(19) United States
(12) Patent Application Publication
(10) Pub. No.: US 2004/0155115 A1
(43) Pub. Date: Aug. 12, 2004

(54) Method and device for controlling a program

(76) Inventor: Stefan Lynggaard, Lund (SE)

Correspondence Address: BIRCH STEWART KOLASCH & BIRCH, PO BOX 747, FALLS CHURCH, VA, 22040-0747, US

(21) Appl. No.: 10/481,513

(22) PCT Filed: Jun. 24, 2002
(86) PCT No.: PCT/SE02/01249

(30) Foreign Application Priority Data
Jun. 21, 2001 (SE) 0102210.2

(51) Int. Cl. G06K 19/06

(52) U.S. Cl. 235/494

(57) ABSTRACT

A method, a system and a product for controlling a program in a computer (15) are described. The program is controlled by means of a product (21) on which there is a position code which defines a number of positions on the surface and on which base an image of at least that shown on the display when the program is executed is printed.

### FIELD OF INVENTION

The present invention relates to a method for controlling a program on a computer including a display.

### BACKGROUND ART

Programs that are executed on computers may be controlled with an input device. The input device may be a keyboard or a mouse but may also be a joystick, a wheel, a digitising table etc. In connection with window-based operating systems, a mouse is used for directing a cursor on the display to different positions and clicking a key on the mouse to activate an event in the program. When the cursor in the window is directed to a button by means of the mouse and a key on the mouse is pressed, an event is activated in the program.

The program may be controlled via a menu system, with a menu bar often at the top of the screen. When an item in the menu bar is selected, a list of possible events is folded down across the screen of the computer.

However, the computer display has a limited size and resolution, which means that only a limited amount of information is shown on the display with a limited resolution. It would therefore be desirable to have an alternative method and an alternative device for controlling a program that is executed on a computer, which method does not have the restrictions of prior-art technique.

### SUMMARY OF THE INVENTION

An object of the present invention is to provide a method and a product for remote controlling a program on a computer.

A further object of the present invention is to provide a simple method for controlling a program that does not require the user to look at the display while controlling the program.

These and other objects are achieved by a method, a product and a system as defined in the independent claims.

A basic idea of the present invention is to control a program on a computer with the aid of a printout of a display image. The display image is printed along with a position-coding pattern which codes absolute coordinates on a virtual surface. By means of the position-coding pattern it is possible to convert of link a position on the sheet of paper into a position on the display.

A method according to the present invention for controlling a program on a computer with a display, on which computer a program is stored, comprises that the program is controlled with the aid of a product, on which product there is printed a position code which defines a number of positions on the product and on which product there is an image of at least that shown on the display as the program is executed, a position on the product being associated with a display position. A handheld device is used for pointing at the product for undertaking actions. The handheld device is arranged to sense the position code and determine its position on the product.

The entire display image may be printed on the product and the user does not have to choose how much of the file which currently is active in the program that should be printed.

By using a product on which there is stored a print-out of what is shown on the display as the program is executed, it will possible to work with the document without having to look at the display. If a larger portion of the file than is shown on the display is printed on the product, it will is possible to work with a large document, such as a large drawing of high resolution, which is difficult to achieve on a display since displays usually have a limited resolution and size.

In order to connect a position on the display to an instruction that is to be carried out when the position is marked, it is preferred for a position code read from the base to be converted into a corresponding position on the display during execution of the program. When marking, for instance, part of a figure on a product on which there is an image of the appearance of the display when a drawing program is being executed, the position on the product is therefore converted into a position on the display, which position on the display is then interpreted in a manner corresponding to that of a mouse being used as a pointing device. However, it is not necessary to convert the position into a display position, and alternatively it is possible to convert a marked position into an instruction which is associated with both the position on the product and the display position.

In the case where the position is converted into a display position, it is preferred for the display position to be sent to a mouse driver which controls a cursor on the display.

The marking of the position on the product is advantageously carried out by recording an image of the position code using a handheld device which is adapted to record position codes.

There are several alternatives to how the position code is converted into a position. However, it is preferred for the conversion of the position code into a position to be made in a handheld device which is arranged to record the position code.

The positions recorded by the handheld device may be sent directly to the computer on which the program is executed. This enables immediate and also interactive control of the program. Preferably the computer is positioned in the vicinity of the user device. The handheld device and the paper interface operates as a mouse.

Alternatively, an image of the position code may be sent to a server which converts the position code into a position which is transferred to the computer. According to this alternative embodiment, the user device always sends the image of the position code to the same server.

A product according to the invention for controlling a window-based program on a computer comprises that at least an image of the program on the display as it appears as the program is executed. In the image there is also a position code. In the image there are also activation fields which are associated with different positions in the position code. The position code is either superimposed on the image or integrated into the image. When the position code is superimposed on the image, it must be separated from the image. When the position code is such as to be detected optically, it may be of such a type that the position code is detected by light at a wavelength other than that of the light that is used to detect the image. PCT publication WO01/71644, which is incorporated herewith by reference, describes how a position code can be integrated into an image.

A user device that is used according to the invention is advantageously a reading pen which preferably is handheld.

Even if it is possible to have more information on the product than what is shown on the display, the product may show the same information as appears on the display. This makes it possible to edit a document at high resolution.

The product may consist of an ordinary sheet of paper on which an image of that shown on the display is printed. By the product being an ordinary sheet of paper, it will be inexpensive to produce while at the same time it can be large.

A system according to the invention for controlling a window-based program comprises a computer, a display and a product. The system is characterised in that there is on the product at least an image of the program on the display as it appears when the program is executed, the image also having a position code and containing activation fields which are associated with different positions in the position code.

A system according to the invention preferably also comprises a handheld device being arranged to record an image of the position code and convert it into a position.

In a system according to the invention, the handheld device may be arranged to send the position to the computer which is arranged to initiate an event in the program in response to the receipt of the position. Alternatively, the position is sent to a server which interprets the position into an instruction, after which the instruction is sent to the computer.

A method according to the invention for operating a computer system comprises: recording an image of a base with a position code, said position code being arranged in such manner that a predetermined part thereof unambiguously defines a position on a virtual surface; converting the recorded image into at least one position; using said at least one position to activate a program which is associated with the position; and carrying out in the program a predetermined instruction which is associated with the position.

In order to produce a product according to the invention, a computer program is used according to the invention, which is arranged to initiate a printout of a product according to the invention.

A method according to the invention may comprise printing the product from the program during execution of the program. During execution of the program, an image is thus shown on the display, in which a user can mark different fields in order to control the program. The image shown during execution is printed at the user's request. Then the user can close the program and again begin execution in the same part of the program as when the product was printed.

The program that is controlled by means of the product is a program that can be controlled using a computer mouse. The program is preferably a window-based program or a menu controlled program.

A computer program according to the invention comprises, according to an additional aspect of the present invention, instructions which make a computer, when receiving a signal, which signal contains a position, activate a program which is associated with the position, and convert the position into a display position, and carry out the instructions that are associated with said display position.

This program can be integrated with the above-mentioned computer program which initiates a printout of the display contents.

The program is distributed either by means of a memory medium on which the computer program is stored or via a computer network to which the computer used by the user is connected. The program is such that the receipt of a signal on an input, which signal contains a position, activates a program that is associated with the position and converts the position into a display position. Subsequently, the instructions that are associated with the display position are carried out.

When the program is received as a signal via a computer network, such as the Internet, it is not necessary for computer to be located in the same country as the country in which the server is located from which the program is fetched.

It goes without saying that the above features can be combined in the same embodiment.

### BRIEF DESCRIPTION OF THE DRAWINGS

Other objects, features and advantages of the invention will become apparent from the following detailed description of several embodiments of the invention with reference to the drawings, in which:

FIG. 1 is a cross-sectional view and shows a handheld device according to an embodiment of the present invention;

FIG. 2 is a schematic diagram and shows a system according to an embodiment of the present invention,

FIG. 3 is a plan view of a product according to an embodiment of the present invention, and

FIG. 4 is a schematic diagram which illustrates how a large virtual surface can be shared among a plurality of different users and a plurality of different programs.

FIG. 5 is a schematic diagram which illustrates the division of the printout in a menu portion and a working area portion.

### DETAILED DESCRIPTION OF EMBODIMENTS OF THE INVENTION

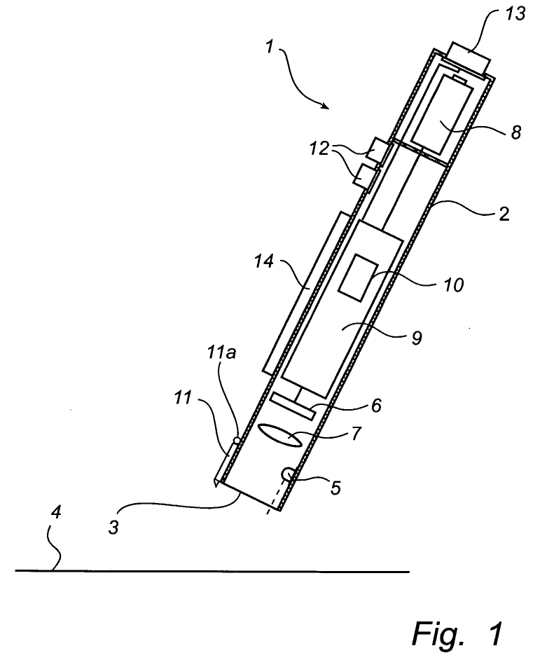

FIG. 1 discloses a handheld device 1 for use in a system according to the invention. The user device 1 comprises a casing 2 having approximately the same shape as a pen. In one short side of the casing there is an opening 3. The short side is intended to abut against or be placed adjacent a product 4.

The device 1 comprises at least one LED, light-emitting diode 5 for illuminating the product 4 which is to be imaged and a light-sensitive area sensor 14, for example a CCD or CMOS sensor, for recording a two-dimensional image. The device 1 may also comprise a lens system 7. The LED may emit light in the infrared wave-length area and the sensor may be sensitive in this are, by means of suitable filters being arranged adjacent the sensor. These components form a digital camera.

The power supply to the device 1 is obtained from a battery 8, which may be rechargeable and is mounted in a separate compartment in the casing 2. Alternatively, the power supply takes place via a cable, such as a USB cable.

The device 1 further comprises image-processing means 9 for determining a position on a product, when the handheld device is placed close to said product, based on the product area recorded by the sensor 6. The image-processing means may be a processor unit 10 which is programmed to read data from the sensor 6 and carry out absolute position determination based on the data, as explained in more detail below.

The device 1 may also comprise a pen point 11, with the aid of which it is possible to write ordinary pigment-based writing on the surface 4 upon which the position determination is to be carried out. The pen point 11 can be extendable and retractable and exchangeable, so that the user can control whether or not it is to be used. The pigment may be transparent for infrared light, so that traces put on the product by the pen point do not interfere with the camera.

The pen point 11 is in operative connection with a transducer 11a, such as a force or pressure transducer, which determines if the pen point is in contact with a product 4, and possible the force of contact with the product.

Moreover, the device 1 may comprise keys 12 by means of which the user activates and controls the device.

The handheld device may comprise a transceiver 19 for wireless transfer, e.g. using IR light or radio waves, of information to and from the device. The transfer of information can also take place using a cable, such as a USB cable.

The device 1 may further comprise a display 14.

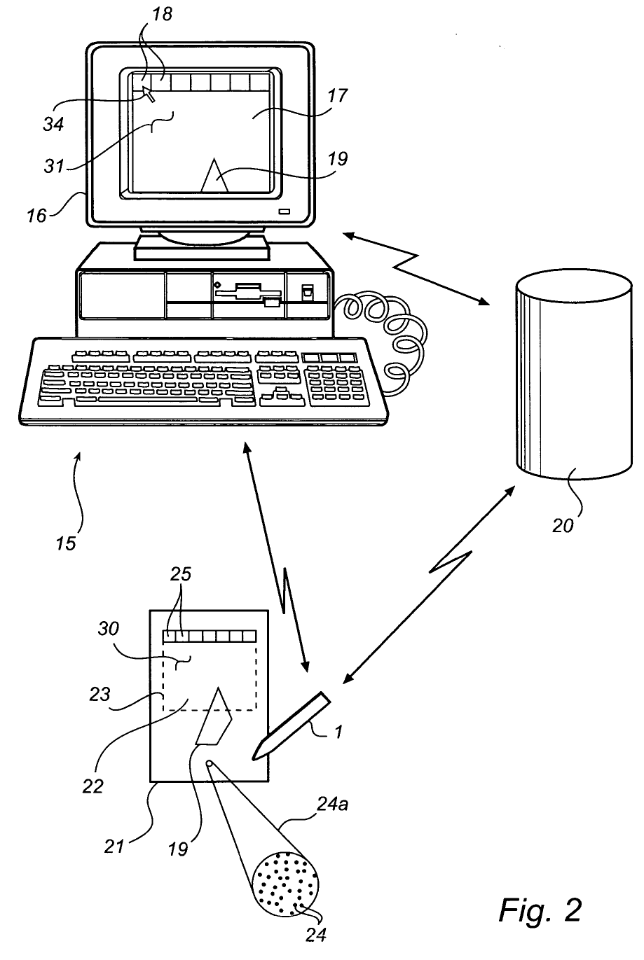

FIG. 2 discloses a system according to an embodiment of the present invention. The system comprises a handheld device or pen 1 as shown in FIG. 1. The system further comprises a computer 15 with a display 16 on which a display image 17 is shown when a program is executed on the computer 15. In the embodiment shown in FIG. 2, the program is a drawing program, such as Microsoft Paint.

On the display 17 there is shown a plurality of function selection buttons 18 for the selection of different functions when processing the program shown on the display. The display also shows part of a document that is being processed by the drawing program.

In FIG. 2, the document comprises a FIG. 19 which is to be edited by means of the drawing program. Since the user wants to see the figure at a predetermined resolution and the display has a limited size, only a part of the FIG. 19 is shown on the display 16. There are scroll bars, so that other portions of the figure can be shown on the display.

FIG. 2 also shows a server 20 which optionally can be included in the system.

A user, who wants to use the present invention, initiates printing of the document into a product 21, which is generated in the form of a sheet of paper.

The product 21 thus receives a copy 22 of the display image 17 shown on the display 16 at the time of printing. That shown on the display 16 corresponds to that shown inside the box 23 indicated by dashed lines on the product 21. Since the product may consist of an ordinary sheet of paper, it can be large, that is sufficiently large to include the entire FIG. 19, also the portion not shown on the display.

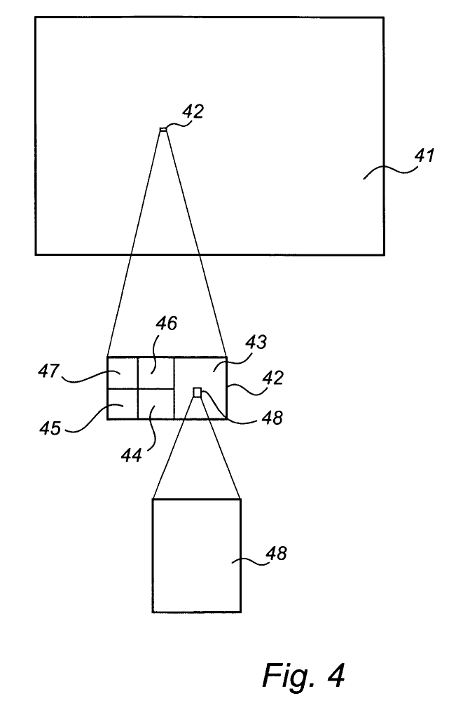

On the product 21 there is also an absolute position code which codes absolute positions on a virtual surface, see FIG. 4. The position code may be present before the printing or may be printed at the same time as the image 22 is printed.

The position code comprises a plurality of hardly visible marks 24, as indicated by the enlargement 24a.

There are also printed activation fields 25 which correspond to the buttons 18 on the display image 17.

Position codes that may be used in the present invention are described in PCT publications WO 01/26032, WO 01/26033, WO 01/26034 and WO 00/73983 which are incorporated in the present specification by reference. The absolute position codes that are described in said publications are able to define a large area. A handheld device, such as a “digital pen” may be used on a paper provided with said position codes. Such a handheld device may be the device described with reference to FIG. 1. The handheld device records a small area of the product in front of the pen comprising said absolute position code and interprets the code into position coordinates, normally x and y coordinates. The pen records its position several times per second, normally about 100 times per second. Thus, the movement of the pen over the product can be traced. The pen records a digital trace as a train of coordinates as well as a physical trace at the product by the pen point 11.

The position code may be dots arranged along an invisible rectangular grid, each dot being displaced in relation to the grid in one of four orthogonal directions. Such displacement codes a “value” of the dot. Thus, each dot may represent any one of the following digital values: “0,0”, “0,1”, “1,0”, and “1,1”. The dots are arranged with a nominal distance of 0.3 mm and are approximately 0.1 mm in diameter, thus being hardly visible by the human eye.

The digital camera records an area of the product which comprises at least 6 times 6 dots, i.e. about 1.8 mm in square, plus some extra space to be certain to include at least 6 times 6 dots. These 36 dots code a digital value that has 2\hat{ }72 possible values, since each dot has 4 possible values. From the code a coordinate can be calculated with the resolution of 0.3 mm. The virtual area that can be coded comprises a vastly large area, larger than the total surface area of the United States. The exact coding appears from the above mentioned PCT publications.

Different areas defined by said code of the virtual area may be assigned to different users. Part of a user's virtual area is in turn assigned to each program that is installed on the user's computer. When a program is activated and shown on the display and the user initiates printing of the product, a position code belonging to the user and the active program will be printed together with the display image. Thus, the printer prints the display image and position codes at the same time. Thus, a relationship is established between the code and the display image.

A user of the system may use the product 21 and the pen 1 to control the program. Since there is a link between the position code and the FIG. 19, because the program has printed these with a certain relationship, the user may use the product 21 instead of the display 19 and the pen 1 instead of the mouse, to control the program. If the pen moves in the drawing area 30, a trace produced by the pen on the product is interpreted by the program as a new line to be added to the FIG. 19, for example. If the pen moves in the activation fields 25, such a digital trace is interpreted as a mouse action in the corresponding button 18. When the pen is moved out of contact with the product, as indicated by transducer 11a, no action is undertaken.

The ink given off by the pen point 11 is of a colour which is transparent for infrared light. Thus, the ink does not hamper the operation of the recording of the code and coordinates determination.

Thus, the operation of the transducer 11a in the action boxes 25 is the same as a click of the mouse in buttons 18. Alternatively, the keys 12 at the pen may be operated to simulate a mouse click.

The relationship between the display 17 and the product 21 may be included in a lookup table, which contains information which connects a position to a certain program that is to be activated, a certain file that is to be activated and information about the display positions that are defined by the sheet of paper. A specific display position is calculated based on the information about the display positions that are defined by the positions on the sheet of paper. The computer then shows a cursor in the specific display position on the display in the document and the program that are associated with the position. The instruction or instructions that is/are executed when a user marks the selected display position with a mouse pointer are then executed on the computer. The reading pen will thus function as a computer mouse, the control program in the computer supplying data to the computer's mouse driver by recording pen movements and translating the position received from the reading pen into a display position.

The control program that receives information from the reading pen and that supplies the display position to the mouse driver is a supplementary program which operates separately from the other programs on the computer. The control program is installed on the computer like any other program, for instance from a disk or from a network server. It is also possible to install the program from a network server connected to the Internet, which network server can be located in a country other than that of the computer. When installing the program on the computer, it will in this case be done by first receiving a data signal containing a packed version of an installation file. When the installation file has been unpacked and executed on the computer, the program will be installed.

The operation will now be described in the form of an example with reference to FIG. 2. When a handheld device records an area of one of the activation fields 25, the pen will determine a position or coordinate. Then, the position is sent to the computer 15 where the position is converted into a display position. The computer may then show a cursor 34 on the display 16 pointing at one of the buttons 18. In this case, the position corresponds to one of the activation fields 25 which in turn corresponds to a button 18 on the display. The program that is executed on the computer communicates with the mouse driver and carries out the instruction associated with the button 18. Therefore the position will in this case be converted into the instruction that corresponds to the button 18 on the display. In this operation, the digital pen replaces a mouse operation and is performed directly as the pen reads the coordinates of the product. The program reacts immediately and must be working on the computer. The user may take a look at the display to see the result.

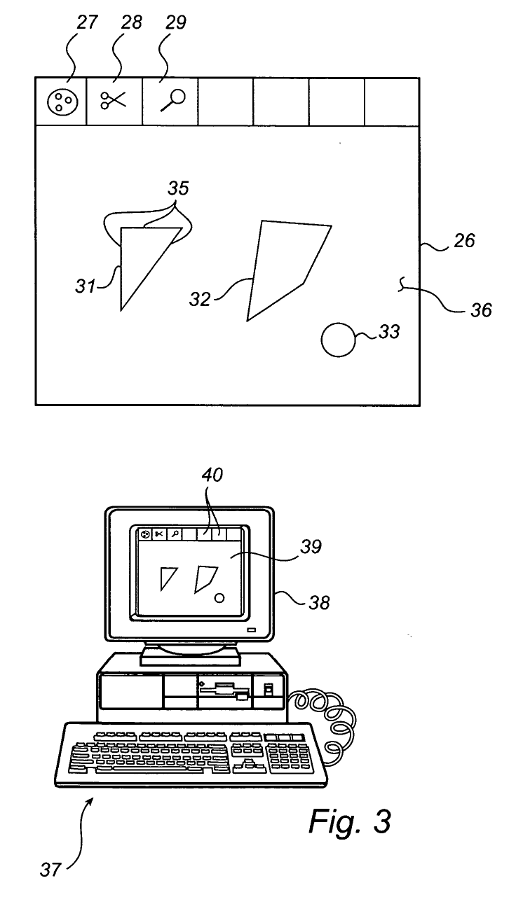

FIG. 3 shows a computer 37 with a display 38 on which an image 39 is shown when a drawing program is executed on the computer 37. On the display, a plurality of buttons 40 are shown, which can be used to control the program when executed on the computer. FIG. 3 also shows a product 26 according to an embodiment of the invention. The product 26 consists of a sheet of paper 36 which has printed thereon an image of that shown on the display when a drawing program is executed. When a user uses the program on the computer, the display image 39 is shown on the display. The user can then initiate a printout of the display image. The sheet of paper on which the display image is printed, also has a position-coding pattern which codes absolute positions on a surface. The sheet of paper on which the display image is printed is in this case twice as long and twice as wide as the display image. As appears from FIG. 3, the printout is made so that the image 39 is enlarged twice, and is thus printed with the double resolution compared to the image on the display.

The sheet of paper has a plurality of activation fields 27, 28, 29 which define different functions or menu alternatives in the program. A first FIG. 31, a second FIG. 32 and third FIG. 33 are present on the sheet of paper. If the user wants to colour the first FIG. 31 with a specific colour, he moves the pen 1 to the first activation field 27, which corresponds to a colour palette, and makes a stroke in the field 27. Thus, the transducer 11a is activated when the pen is pressed against the product in the field 27. This corresponds to a mouse action in the corresponding first button 40 on the display. Then, the user places the pen inside the first FIG. 31, and again the transducer 11a is activated by the touch of the pen on the product, and this is interpreted as a mouse click inside the FIG. 31. The combined action is then that the FIG. 31 is filled with a colour that has been predefined, such as green.

The FIG. 31 on the paper will not be coloured green, but the next time the display image is printed out, the FIG. 31 will be shown green.

The actions described above may be performed in real time, as a mouse action, if the computer 37 is active and the program has been started, as described above. However, the pen strokes may be stored in the pen and sent to the computer 37 at a later time, and then perform the above actions in sequence. The pen strokes may further be stored in the computer 37 for a while if the computer is busy with other tasks or the program is not running. When the program is started the next time, the pen actions may be transferred and performed. Thus, a user may use the pen and the product 26 to do a multitude of additions and amendments of the figures, and all amendments are transmitted at the same time, either directly on line, or later when contact is established. Some of the amendments will appear on the product 26 when the user is working on the product, namely those related to the drawing of new lines or figures, while other may be invisible, such as the colouring described above.

The control program which controls the conversion of a product position into a display position and which controls the printing of the display image on a sheet of paper is an accessory program which is bought as an accessory. The accessory program also provides a display position to the mouse driver which in turn is used by the program that is currently active.

According to an alternative embodiment, the reading pen sends the recorded position to an external server 20 where the recorded position is converted into an address to a computer that is associated with the position. Then the computer processes the information in the same way as described above. In this case the server is a central server for a plurality of computers.

The product may be provided with a coded pattern before being printed with the display image. In this case, the display image is printed without the code. A relationship between the display image and the code is established in the following way. The print head of the printer, such as an inkjet printer, is provided with a “camera” and processing circuitry similar to a digital pen 1. The print head reads the code on the paper at the same time as the display image is printed on the paper and send the code to the program from where the print-out is obtained, so that the program may correlate the display image and the code. Thus, the display image and the code is synchronised. The print head may print the display image with an ink that is transparent for infrared light, so that the display image does not interfere with the code and the coordinate determination.

FIG. 4 shows how a large virtual surface can be shared among a plurality of different users and be used in a plurality of different programs. The position-coding pattern codes a virtual surface 41. A user buying the accessory program as described above, gains access to a sub area 42 which the user can divide according to his own requirements into a number of partial sub-areas 43, 44, 45, 46, 47. A first partial sub area 43 is assigned a word processing program and has, according to the user's requirements, been assigned a larger area than the other programs since it is the word processing program that the user uses most. The first partial sub area is in turn divided into a plurality of document areas 48. A page in the document is associated with a document area. When a user as described above records an image, the image is converted into a position. Then it is identified with which document and with which program the position is associated. After that the document is opened in the program concerned. The administration of the sub area 42 can, of course, be handled entirely by the computer. The user thus need not take care of the handling. In order not to risk that the surface runs out, it would be possible to use an internal open dating on the surfaces that are used when printing the product so that it will be possible to use the area for a new purpose a predetermined period of time after the first product has been printed.

According to an alternative embodiment of the present invention, the position that has been recorded using the reading pen is sent to the computer where it is converted into an instruction that is to be carried out in the program that is being executed on the computer. In this case, the accessory program that performs the conversion of a position into an instruction should be integrated with the program that is executed on the computer.

In FIG. 3, the activation fields 27, 28, 29 are printed at the same time as the FIGS. 31, 32, 33 on a continuous code. However, the activation fields may be printed separately, since they are always the same for a specific program. In this case, the activation fields may be printed at area 47, see FIG. 4, while the image 39 is printed in a separate area 43.

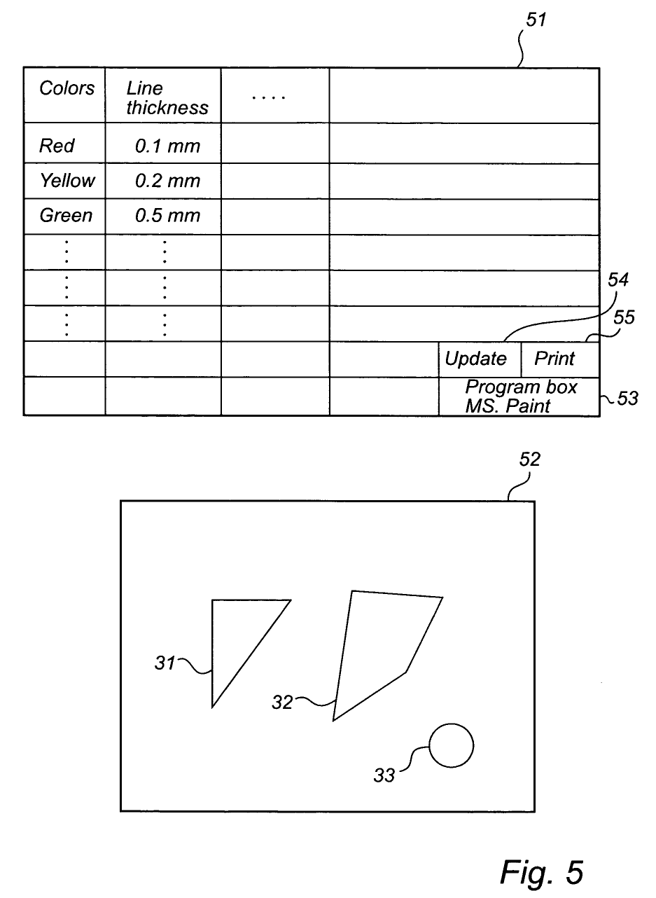

FIG. 5 discloses a menu system 51 printed separately from a working area 52 on a product, such as a paper. The menu system 51 may be stored in a library of menu system and is not reprinted. Only if the menu system is getting cluttered, it is reprinted. Each menu system may be associated with a separate code area, for example the program Microsoft Paint may be associated with area 44, see FIG. 4, Microsoft Power Point may be associated with area 45, etc.

Each menu system is a continuous code area, so that the coordinates for adjacent menu items has adjacent code positions.

An alternative solution is to assign each command a specific code and place the menu command anywhere on the paper. When the digital pen is placed in the menu command box, it records the coordinates of the code in the relevant box, which is linked to a certain menu alternative.

The working area may be chosen from the code area 43, independently of the program. The relevant program to interact with may be chosen by a program box 53 in the menu portion. A tick in the program box 53 initiate the relevant program in the computer or changes the computer to the relevant program if that is not the current program on the computer. Of course, a tick in any of the menu alternatives will result in that the corresponding program is addressed.

Another approach is to assign each program display image to separate code areas.

The menu system may also be provided with an update box 54 and a print box 55. A tick in the update box 54 sends all coordinates, traces and data stored in the pen 1 to the computer, possibly via a network system such as Internet. The program is started and the file is updated with all strokes performed since the last update. A tick in the print box 55 prints a new working area 52 with the current display image. A line drawn through the update box 54 and the print box 55, then updates the program and prints a new working area 52. The printing may take place remotely, so that the print data is sent over a network system, such as Internet, to a printer close to the user and specified by the user.

Thus, the work could be performed at any place, such as on an airplane during the flight, and the updating can take place when the airplane has landed and the user has contact with his computer.

It is also mentioned that the instructions from the pen to the program can be transmitted, for example over the Internet, to a remote computer to control the program at said computer, and the output may be transmitted, for example over the Internet, to the user, which may be at an Internet connected computer elsewhere, that do not have the relevant program. Else, the output may be sent as a fax to the user for further work or for checking the end result.

Thus, the instructions from the pen to the computer and program can be transmitted immediately or delayed. They can be interpreted by the computer and the program immediately or delayed. The output can be sent to the user immediately or delayed.

Some programs are controlled by a large menu system, such as the program Microsoft Paint or Microsoft Power Point, which both are present on many personal computers today.

Such a program as Microsoft Power Point even has multiple menu systems, one for controlling operations like Edit, and one for controlling the drawing properties. Each menu system may have several levels of menus. Thus, the command “Insert” “Picture” “From file” has three levels. These menus fold out from the top or bottom of the display and cover the working space. The user must control the mouse carefully to activate the right command. Such a menu system does not lend itself to be printed on a sheet of paper, since the layout on the paper is not interactive.

However, the reason for having a multilayer menu system is often because of lack of space on the display. The paper, however, can be made large enough to incorporate all commands of a complex menu system. Thus, according to the invention, for each program there is generated a corresponding paper layout including the menu commands, which is printed on the paper, for example in the code area 47. The multilayer menu system is replaced by a two-dimensional system 51, that can be printed on a paper or other product.

There may be a separate code area for each program menu system, with separate coordinates for each program. Since the paper has a high resolution, each menu command may be made small, say a box in the size of 3 times 3 mm. The pen may easily be placed at the area to generate the relevant command. Often used commands may occupy larger boxes.

Thus, the command area is separated from the working area in the digital domain. In the physical domain, the menu system may be printed on the same product or page as the working area, or they may be printed on separate papers.

One possibility is to print the menu system of the programs a user often use, such as Microsoft Word, Microsoft Power Point, Microsoft Excel, Microsoft Paint, Adobe Acrobat etc, and collect these menu system in a folder. Then, only the working area needs to be printed for each occasion, since the menu system is already present for the user.

The layout of the menu system may be adjusted by the user, so that the commands he uses most often are easy to find for him. There may also be a default layout. Some commands are not relevant when working from a distance and can be omitted, such as the Window commands in Microsoft Power Point.

The high resolution of the paper may be used for increasing the visible area of the working document as shown in FIG. 2 or for increasing the resolution as shown in FIG. 3.

Although it has been described in the embodiments above that the reading pen communicates directly with the computer it is, of course, possible for it to do so via a server.

Although the above embodiments only show that the position code is recorded optically, it is, of course, possible and within the scope of the invention to record the position code in some other way.

The invention has been described above with reference to certain embodiments of the invention with reference to the drawings. However, the different features may be combined in other ways then specifically described. Moreover, the described embodiments are only for elucidating the invention and are not limiting. The invention is only limited by the appended patent claims.

1. A method for controlling a menu-based program of a computer (15, 37) with a display (16, 38), characterised in that the program is controlled with the aid of a product, which product (21, 26) comprises a position code which defines a plurality of positions on the surface and which product comprises a copy of a display image of at least that shown on the display as the program is executed, a position on the product being associated with a display position.

2. A method as claimed in claim 1, characterised in that a position code read from the product (21, 26) is converted into a corresponding display position.

3. A method as claimed in claim 2, characterised in that the display position is sent as an input signal to a mouse driver which controls a cursor on the display.

4. A method as claimed in claim 1, 2 or 3, characterised in that the position code codes absolute positions on a virtual surface.

5. A method as claimed in any one of the preceding claims, characterised in that the position code is converted into a position in a user device (1) which is arranged to record images of a position code.

6. A method as claimed in claim 5, characterised in that the position is sent to the computer (15, 37) which converts the position into a display position.

7. A method as claimed in any one of claims 1-4, characterised in that an image of the position code is sent to a server (20) which converts the image into a position which is transferred to the computer (15, 37).

8. A method as claimed in any one of the preceding claims, characterised in that the computer (15, 37) carries out the instructions that are defined by said display position.

9. A method as claimed in any one of the preceding claims, characterised in that the product is printed from the computer (15, 37) during execution of the program.

10. A method as claimed in any one of the preceding claims, characterised in that the copy of the display is divided in a menu area and a working area.

11. A method as claimed in claim 10, characterised in that the menu area is printed on a separate product having a separate code and that the working area is printed on a another product having another code.

12. A product for controlling a menu-based program on a computer (15, 37), characterised in that the product comprises a copy of at least that shown on the display (16, 38) when the program is executed and that the product also has a position code, a position on the product being associated with a display position.

13. A product as claimed in claim 12, characterised in that the image comprises activation fields (25, 27, 28, 29) which correspond to buttons that are shown on the display when the program is executed.

14. A product as claimed in claim 12 or 13, characterised in that the product comprises a copy which shows more information than what is shown on the display (16, 38).

15. A product as claimed in claim 12, 13 or 14, characterised in that the product comprises a menu system for controlling the program and printed in one code area, and a working area comprising at least a copy of the display image printed in another code area.

16. A system for controlling a menu-based program, comprising a computer (15, 37) and a display (16, 28), characterised in that the system comprises a product (21, 26) on which there is a copy of at least that shown on the display (16, 38) as it appears when the program is executed, the image also having a position code, a position on the product being associated with a display position, and that the system further comprises a user device (1), the user device being arranged to record an image of the position code.

17. A system as claimed in claim 16, characterised in that the image comprises activation fields which correspond to buttons that are shown on the display when the program is executed.

18. A system as claimed in claim 16 or 17, characterised in that the user device is arranged to send the position to the computer which is arranged to convert the position into a display position.

19. A system as claimed in claim 18, characterised in that the computer is arranged to send the display position to a mouse driver which is arranged to control a cursor on the display.

20. A method for operating a computer system comprising a computer, characterised by the steps of
recording an image of a product (21, 26) with a position code, which position code is arranged in such manner that a predetermined part thereof unambiguously defines a position,
converting the recoded image into at least one position,
using said at least one position to activate a program which is associated with a position,
calculating a display position which is associated with the position.

21. A memory medium on which a computer program is stored, which comprises instructions which make a computer initiate production of a product according to claim 12.

22. A memory medium on which a computer program is stored, which comprises instructions which make a computer (15, 37) activate, when receiving a signal, which signal contains a position, a program which is associated with the position, and convert the position into a display position.

23. A memory medium as claimed in claim 22, wherein the computer program further comprises instructions which make the computer (15, 37) identify in an input signal key depressions which are associated with the position, and carry out the instructions associated with the display play position and the number of key depressions identified in the signal.

24. A memory medium as claimed in claim 22 or 23, wherein the computer program also comprises instructions which make the computer (15, 37) send a signal containing the display position to a mouse driver which controls a cursor on the display.

25. A method in a computer provided with a display, for controlling a program stored in the computer, characterised by the steps of:
receiving a request, initiated by a user, for printing an image of at least that shown on the display as the program is executed;
assigning said image a number of absolute positions;
associating, in a lookup table, the thus-assigned absolute positions with the program;
initiating printing of the image and a position code that codes the thus-assigned absolute positions within the image,
upon receipt of a signal including at least one absolute position from a user device which is arranged to record said position code, identifying the program based on the lookup table;
converting the thus-received absolute position to a display position; and
bringing the computer to control the program based on the display position.

26. A method as claimed in claim 25, comprising the step of activating, upon said receipt of at least one absolute position, the program in the computer.

27. A method as claimed in claim 26, wherein the step of bringing the computer to control the program includes outputting the display position as an input signal to a mouse driver which controls a cursor on the display, such that the computer carries out instructions that are defined by the display position in the activated program.

28. A method as claimed in claim 26 or 27, wherein the step of identifying the program also includes identifying a file, whereupon the file is opened in the program.

29. A method as claimed in any one of claims 25-28, wherein the step of assigning the image a number of absolute positions includes: identifying, based on the user, an accessible subset of absolute positions on a virtual surface which is coded by the position code; and automatically assigning the image said number of absolute positions within the accessible subset.

30. A method as claimed in claim 29, wherein the step of assigning said image a number of absolute positions further includes: identifying, based on the program, an accessible sub-subset of the accessible subset; and automatically assigning the image said number of absolute positions from the accessible sub-subset.

31. A method as claimed in claim 30, wherein said program is a word processing program, and wherein the word processing program is assigned one of said sub-subsets, which is divided into a plurality of document areas, each of which is adapted to be associated with one page of a document, said method comprising the step of assigning the image, which represents at least part of the page, said number of absolute positions from one of the document areas.

32. A method as claim in any one of claims 25-31, comprising the steps of: open dating the thus-assigned absolute positions, and allowing for re-use of the thus-assigned absolute positions a predetermined time period after the printing of the image.

33. A method as claimed in any one of claims 25-32, wherein the image includes activation fields, which correspond to buttons shown on the display as the program is executed.

34. A method as claimed in any one of claims 25-33, wherein the image in printed from the computer during execution of the program executed.

35. A memory medium on which a computer program is stored, which comprises instructions which make a computer effect a method as claimed in any one of claims 25-34.
